(19) United States
(12) Patent Application Publication
(10) Pub. No.: US 2004/0029014 A1
(43) Pub. Date: Feb. 12, 2004

(54) Positive electrode for lithium-sulfur battery, method of producing same, and lithium-sulfur battery

(75) Inventors: Duck-Chul Hwang, Suwon-city (KR); Zin Park, Suwon-city (KR); Jae-Woan Lee, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD., Suwon-city (KR)

(21) Appl. No.: 10/634,748

(22) Filed: Aug. 6, 2003

(30) Foreign Application Priority Data
Aug. 7, 2002 (KR) 2002-46581

(51) Int. Cl. H01M 2/16; H01M 4/60; H01M 4/58

(52) U.S. Cl. 429/246; 429/251; 429/252; 429/218.1; 429/213

(57) ABSTRACT

A positive electrode of a lithium-sulfur battery, a method of producing the same, and a lithium-sulfur battery include, as the positive electrode, a current collector, a positive active material layer on the current collector, and a polymer layer on the positive active material on the current collector.

### CROSS-REFERENCE TO RELATED APPLICATIONS

This application is based on application 2002-46581 filed in the Korean Intellectual Property Office on Aug. 7, 2002, the disclosure of which is incorporated hereinto by reference.

### BACKGROUND OF THE INVENTION

1. Field of the Invention

The present invention relates to a positive electrode for a lithium-sulfur battery, a method of producing the same, and a lithium-sulfur battery, and more particularly, to a positive electrode for a lithium-sulfur battery exhibiting a high initial capacity.

2. Description of the Related Art

The continued development of portable electronic devices has led to a corresponding increase in the demand for secondary batteries having both a lighter weight and a higher capacity. To satisfy these demands, the most promising approach is a lithium-sulfur battery with a positive electrode made of sulfur-based compounds.

Lithium-sulfur batteries use sulfur-based compounds with sulfur-sulfur bonds as a positive active material, and a lithium metal or a carbon-based compound as a negative active material. The carbon-based compound is one that reversibly intercalates or deintercalates metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are re-formed, resulting in an increase in the oxidation number of the S. The electrical energy is stored in the battery as chemical energy during charging, and is converted back to electrical energy during discharging.

With respect to specific density, the lithium-sulfur battery is the most desirable among the currently developing batteries since lithium has a specific capacity of 3,830 mAh/g, and sulfur has a specific capacity of 1,675 mAh/g. Further, the sulfur-based compounds are less costly than other materials, and are environmentally friendly.

However, employing a positive electrode based on elemental sulfur in an alkali metal-sulfur battery system has been considered problematic. Although theoretically the reduction of sulfur to an alkali metal-sulfide confers a large specific energy, sulfur is known to be an excellent insulator, and problems using sulfur for an electrode have been noted. Such problems include a very low percentage of utilization and a low cycle life characteristic as a result of the sulfur and lithium sulfide (Li₂S) dissolved and diffused from the positive electrode.

Thus, there have been various studies to improve the electrochemical reduction-oxidation (redox) reaction and increase capacity.

One study uses a separator including a pseudo-bohemite layer and a protective polymer coating layer, disclosed in U.S. Pat. No. 6,183,901 (Moltech). This method maintains the mechanical strength of the separator and reduces the pore size, facilitating transfer of materials participating in electrochemical reactions. However, this does not directly facilitate electrochemical reactions, and the increase in capacity is slight. Furthermore, the pseudo-bohemite layer is very brittle so that it is difficult to wind during battery preparation.

### SUMMARY OF THE INVENTION

It is an aspect of the present invention to provide a positive electrode for a lithium-sulfur battery with an improved electrochemical reaction, exhibiting high capacity.

It is another aspect to provide a method of preparing a positive electrode for a lithium-sulfur battery.

It is still another aspect to provide a lithium-sulfur battery comprising the same.

These and/or other aspects may be achieved by a positive electrode for a lithium-sulfur battery including a current collector, a positive active material layer on the current collector, and a polymer layer on the positive active material layer on the current collector.

To achieve these and/or other aspects, the present invention includes a method of producing a positive electrode for a lithium-sulfur battery. In this method, a positive active material, a conductive agent, and a binder are mixed in an organic solvent to prepare a positive active material composition and the positive active material composition, is coated on a current collector to form a positive active material layer thereon. The coated current collector is then immersed in a polymer solution to form a polymer layer on the positive active material layer on the current collector.

The present invention further includes a lithium-sulfur battery including the positive electrode, a negative electrode, and an electrolyte. The negative electrode includes a negative active material selected from a material that intercalates or deintercalates lithium ions, a material that reacts with lithium ions to prepare a lithium-included compound, a lithium metal, or a lithium alloy.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a side cross-sectional view showing a positive electrode of a lithium-sulfur battery of an embodiment of the present invention;

FIG. 2 is a perspective view showing a lithium-sulfur battery fabricated using the positive electrode of an embodiment of the present invention;

FIG. 3 is a graph illustrating an initial capacity of the lithium-sulfur batteries according to Examples 1 to 3 and Comparative Example 1;

FIG. 4 is a graph illustrating an initial capacity of the lithium-sulfur batteries according to Examples 4 to 6 and Comparative Example 2; and

FIG. 5 is a graph illustrating an initial capacity of the lithium-sulfur batteries according to Examples 7 to 9 and Comparative Example 3.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A positive electrode of an embodiment of the present invention includes a current collector, a positive active material layer on the current collector, and a polymer layer on the positive active material layer.

The polymer layer includes a polymer into which an electrolyte is easily absorbed. That is, the polymer has an effective ability to absorb the electrolyte. The absorbed electrolyte acts as a solvent in a discharge reaction of the lithium-sulfur battery, in which lithium transferred from a negative electrode reacts with sulfur (S₈) in a positive electrode to generate lithium polysulfide (Li₂S₈), and the absorbed electrolyte facilitates such a reaction. As a result of the absorption, the electrolyte is effectively made available on the positive electrode due to the polymer, and increases the discharge capacity. This effect is not achieved with lithium-ion batteries, but is achieved with lithium-sulfur batteries due to significantly different mechanisms thereof. Furthermore, even though the use of a polymer in lithium-ion polymer batteries is disclosed in U.S. Pat. No. 5,688,293 (Motorola) and Japanese Patent Laid-open Hei 10-162802, an improvement of capacity because of the polymer is not mentioned.

Such a polymer may be polyvinylidene fluoride, a copolymer of polyvinylidene fluoride and hexafluoropropylene, poly(vinylacetate), poly(vinyl butyral-co-vinyl-alcohol-co-vinyl acetate), poly(methylmethacrylate-co-ethyl acrylate), polyacrylonitrile, polyvinyl chloride co-vinyl acetate, polyvinylalcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene-styrene, a sulfonated styrene/ethylene-butylene triblock copolymer, polyethylene oxide, and a mixture thereof. Preferred polymers are polyethylene oxide, polyvinylidene fluoride, or polyvinylpyrrolidone.

The polymer layer may further include at least one lithium salt selected from lithium hexafluorophosphate (LiPF₆), lithium tetrafluoroborate (LiBF₄), lithium hexafluoroarsenate (LiAsF₆), lithium perchlorate (LiClO₄), lithium trifluoromethane sulfonate (LiSO₃CF₃), lithium bis(trifluoromethyl) sulfonimide (LiN(SO₂CF₃)₂), or a mixture thereof. The addition of such a lithium salt to participate in the electrochemical reaction renders an increase in capacity.

The polymer layer may further include an inorganic material. Such an inorganic material forms a structure that prevents breakdown of the structure of the polymer layer during repeated charge and discharge to prevent leakage of the electrolyte or the dissolved positive active materials. The inorganic material may be colloidal silica, amorphous silica, surface treated silica, colloidal alumina, amorphous alumina, conductive carbon, tin oxide, titanium oxide, titanium sulfide (TiS₂), zirconium oxide (ZrO₂), iron oxide, iron sulfide (FeS), iron titanate (FeTiO₃), vanadium titanate (VTiO₃), vanadium oxide, or a mixture thereof.

The thickness of the polymer is preferably 3 to 15 μm. Too thin a polymer layer absorbs such a small volume of the electrolyte that an increase in capacity is not obtained. The polyethylene oxide may improve ionic conductivity, but too heavy a polymer layer has reduced ionic conductivity, thus deteriorating battery performance.

The positive electrode includes a positive active material including elemental sulfur (S8), a sulfur-based compound, or a mixture thereof. The sulfur-based compound is selected from an organic-sulfur compound or a carbon-sulfur polymer ((C₂Sₓ)ₙ: x=2.5 to 50, n≧2).

The positive electrode of a lithium-sulfur battery will be illustrated in more detail. A binder, a conductive material, and a positive active material are mixed in an organic solvent to prepare a positive active material composition. It is preferable to use a solvent that homogeneously disperses the positive active material, the binder, and the conductive material, and is easily evaporated. Useful solvents include, but are not limited to, acetonitrile, methanol, ethanol, tetrahydrofurane, water, and isopropyl alcohol.

Examples of the binder include, but are not limited to, poly(vinyl acetate), polyvinyl alcohol, polyethylene oxide, polyvinyl pyrrolidone, polyethylene oxide, cross-linked polyethylene oxide, polyvinyl ether, poly(methyl methacrylate), polyvinylidene fluoride, a copolymer of polyhexafluoropropylene (marketed under the name “Kynar”) and poly(ethyl acrylate), polytetrafluoroethylene, polyvinylchloride, polyacrylonitrile, polyvinylpyrridine, polystyrene, and derivatives, blends, and copolymers thereof.

Examples of the conductive material include, but are not limited to, a conductive material such as graphite- or carbon-based materials, or a conductive polymer. The graphite-based materials include KS 6 (manufactured by TIMCAL COMPANY), and the carbon-based materials include SUPER P (manufactured by MMM COMPANY), ketjen black, denka black, acetylene black, carbon black, and the like. Examples of the conductive polymer include, but are not limited to, polyaniline, polythiophene, polyacetylene, polypyrrole, and the like. The conductive material may be used singularly or as a mixture of two or more of the above conductive materials. The amounts of the solvent, the positive active material, the binder, the conductive material, and the optional additive are not critical, but must be sufficient to provide a suitable viscosity such that the composition may be coated easily.

The composition is coated onto a current collector, and the coated collector is vacuum dried to form a positive active material layer on the current collector. The composition is coated to a predetermined thickness, depending on the viscosity of the slurry and the thickness of the positive electrode to be prepared. Examples of the current collector include, but are not limited to, a conductive material such as stainless steel, aluminum, copper, titanium, or nickel. It is generally preferable to use a carbon-coated aluminum current collector. The carbon-coated aluminum current collector has excellent adhesive properties to adhere to the active materials, shows a lower contact resistance, and shows a better resistance to corrosion caused by the polysulfide as compared to the resistance of an uncoated aluminum current collector.

The current collector coated with the positive active material layer is coated with a polymer liquid to produce a positive electrode. The polymer liquid is obtained by dissolving 3 to 10 wt % of a polymer in a solvent. The solvent depends on the type of polymer to be used. For example, if polyvinylidene fluoride polymer is used, dimethyl formamide or N-methylpyrrolidone is used as the solvent. If polyvinyl pyrrolidone polymer is used, an isopropyl alcohol solvent, an N-methylpyrrolidone solvent, or a dimethyl formamide solvent is used. If a polyethylene oxide polymer is used, an acetonitrile solvent is used.

The coating process may be performed by an impregnation method such as dip coating, a spray method, or by using another suitable general-purpose coating technique. Any other coating techniques, if available and applicable, may be as effective as the methods described herein. A common method of the coating process is immersing the current collector coated with the positive active material layer in the polymer liquid.

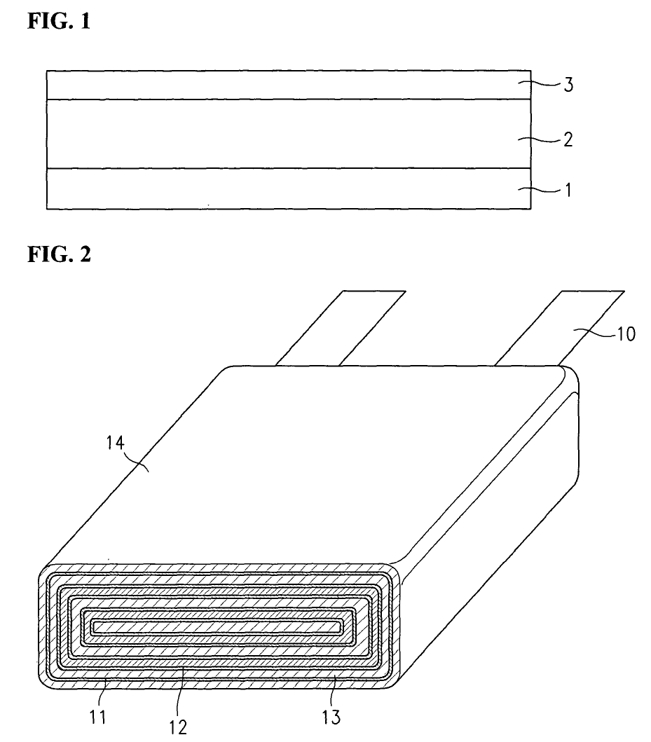

The obtained positive electrode is presented in FIG. 1. As shown in FIG. 1, the positive electrode includes a current collector 1, a positive active material layer 2 on the current collector, and a polymer layer 3 on the positive active material layer.

An embodiment of a lithium-sulfur battery 10 of the present invention, as shown in FIG. 2, includes the positive electrode 11, a negative electrode 12, and a separator 13 interposed between the positive electrode 11 and the negative electrode 12. The positive electrode 11, the negative electrode 12, and the separator 13 are received in a battery case 14. The electrolyte is inserted between the positive electrode 11 and the negative electrode 12.

The negative electrode 12 of the lithium-sulfur battery 1 includes a negative active material selected from a material in which lithium intercalation reversibly occurs, a material that reacts with lithium ions to form a lithium-containing compound, a lithium metal, or a lithium alloy.

The materials in which lithium intercalation reversibly occurs are carbon-based compounds. Any carbon-based compound may be used as long as it is capable of intercalating and deintercalating lithium ions. Examples of such carbon materials include crystalline carbon, amorphous carbon, or a mixture thereof.

Examples of the material that reacts with lithium ions to form a lithium-containing compound include, but are not limited to, tin oxide (SnO₂), titanium nitrate, and Si. The lithium alloys include an alloy of lithium and a metal selected from Na, K, Rb, Cs, Fr, Be, Mg, Ca, Sr, Ba, Ra, Al, or Sn.

The negative electrode may include an inorganic protective layer, an organic protective layer, or a mixture thereof, on a surface of lithium metal. The inorganic protective layer includes Li, P, O, S, N, B, Al, F, Cl, Br, I, As, Sb, Bi, Si, Ge, In, TI, Mg, Ca, Sr, or Ba. The organic protective layer includes polyethylene oxide or polypropylene oxide, or at least one acrylate-based monomer selected from polyethylene glycol diacrylate, polypropylene glycol diacrylate, ethoxylated glycol diacrylate, polypropylene glycol diacrylate, ethoxylated neopentyl glycol diacrylate, ethoxylated bisphenol A diacrylate, ethoxylated aliphatic urethane acrylate, ethoxylated alkylphenol acrylate, or alkyl acrylate.

The organic protective layer may be polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, sulfonated styrene/ethylene-butylene triblock copolymer, polyethylene oxide, or a mixture thereof.

In addition, during charging and discharging of the lithium-sulfur battery, the positive active material (active sulfur) converts to an inactive material (inactive sulfur), which may be attached to the surface of the negative electrode. The inactive sulfur, as used herein, refers to sulfur that has no activity upon repeated electrochemical and chemical reactions and thus cannot participate in an electrochemical reaction of the positive electrode. The inactive sulfur on the surface of the negative electrode acts as a protective layer of the lithium negative electrode. Accordingly, lithium metal with an inactive sulfur (e.g., lithium sulfide) surface may be used in the negative electrode.

The separator 13 may be an organic single layer or a multiple layer made of polyethylene or polypropylene.

The electrolyte includes an organic solvent and a lithium salt. The organic solvent may be at lease one selected from benzene, fluorobenzene, toluene, dimethylformamide, dimethylacetate, trifluorotoluene, xylene, cyclohexane, tetrahydrofurane, 2-methyltetrahydrofurane, cyclohexanone, ethanol, isopropyl alcohol, dimethyl carbonate, ethylmethyl carbonate, diethyl carbonate, methylpropyl carbonate, methyl propionate, ethyl propionate, methyl acetate, ethyl acetate, propyl acetate, dimethoxyethane, 1,3-dioxolane, diglyme, tetraglyme, ethyl carbonate, propyl carbonate, γ-butyrolactone, or sulforane.

The lithium salt may be at least one selected from lithium hexafluorophosphate (LiPF₆), lithium tetrafluoroborate (LiBF₄), lithium hexafluoroarsenate (LiAsF₆), lithium perchlorate (LiClO₄), lithium trifluoromethane sulfonate (LiSO₃CF₃), lithium bis(trifluoromethyl) sulfonimide (LiN(SO₂CF₃)₂), or lithium bis(perfluoroethylsulfonyl)imide (LiN(SO₂C₂F₆)₂).

The concentration of the lithium salt is approximately 0.1 to 2.0 M.

Hereinafter, the present invention will be explained in detail with reference to specific examples. These specific examples, however, should not in any sense be interpreted as limiting the scope of the present invention and equivalents thereof.

### EXAMPLE 1

60 wt % of an elemental sulfur (S₈) active material, 20 wt % of a carbon conductive material, and 20 wt % of a polyvinylidene fluoride binder were dissolved in a dimethyl formamide solvent to prepare a slurry. The slurry was coated on a carbon-coated Al current collector. The coated current collector was dried and pressed. The pressed current collector was coated with a polymer liquid. The polymer liquid was prepared by dissolving polyvinylidene fluoride in a methyl formamide solvent. The concentration of the polymer liquid was 5 wt %.

The resulting current collector was dried at room temperature for 2 hours or more, and then at 50° C. for 12 hours or more to produce a positive electrode.

Using the positive electrode and a lithium foil negative electrode, a lithium-sulfur cell was fabricated. As an electrolyte, 1 M LiSO₃CF₃ in a mixed solvent of 1,3-dioxolane, diglyme, sulforane, and dimethoxy ethane (50:20:10:20 volume ratio) was used.

### EXAMPLE 2

A lithium-sulfur cell was fabricated by the same procedure as in Example 1, except that polymer liquid that was prepared by dissolving polyvinylpyrrolidone in an isopropyl alcohol solvent was used.

### EXAMPLE 3

A lithium-sulfur cell was fabricated by the same procedure as in Example 1, except that a polymer liquid that was prepared by dissolving polyethylene oxide in an acetonitrile solvent was used.

### EXAMPLE 4

60 wt % of an elemental sulfur (S₈) active material, 20 wt % of a carbon conductive material, and 20 wt % of a polyvinylpyrrolidone binder were dissolved in an isopropyl alcohol solvent to prepare a slurry. The slurry was coated on a carbon-coated Al current collector, and the coated current collector was dried and pressed. The pressed current collector was coated with a polymer liquid that was prepared by dissolving polyvinylidene fluoride in a methyl formamide solvent at a concentration of 5 wt %.

The resulting current collector was dried at room temperature for 2 hours or more and then dried at 50° C. for 12 hours or more to produce a positive electrode.

Using the positive electrode, and a lithium foil negative electrode, a lithium-sulfur cell was fabricated. As an electrolyte, 1 M LiSO₃CF₃ in a mixed solvent of 1,3-dioxolane, diglyme, sulforane, and dimethoxy ethane (50:20:10:20 volume ratio) was used.

### EXAMPLE 5

A lithium-sulfur cell was fabricated by the same procedure as in Example 4, except that a polymer liquid that was prepared by dissolving polyvinylpyrrolidone in an isopropyl alcohol solvent was used.

### EXAMPLE 6

A lithium-sulfur cell was fabricated by the same procedure as in Example 4, except that a polymer liquid that was prepared by dissolving polyethylene oxide in an acetonitrile solvent was used.

### EXAMPLE 7

60 wt % of an elemental sulfur (S₈) active material, 20 wt % of a carbon conductive material, and 20 wt % of a polyethylene oxide binder were dissolved in an acetonitrile solvent to prepare a slurry. The slurry was coated on a carbon-coated Al current collector, and the coated current collector was dried and pressed. The pressed current collector was coated with a polymer liquid that was prepared by dissolving polyvinylidene fluoride in a methyl formamide solvent at a concentration of 5 wt %.

The resulting current collector was dried at room temperature for 2 hours or more and then at 50° C. for 12 hours or more to produce a positive electrode.

Using the positive electrode, and a lithium foil negative electrode, a lithium-sulfur cell was fabricated. As an electrolyte, 1 M LiSO₃CF₃ in a mixed solvent of 1,3-dioxolane, diglyme, sulforane, and dimethoxy ethane (50:20:10:20 volume ratio) was used.

### EXAMPLE 8

A lithium-sulfur cell was fabricated by the same procedure as in Example 7, except that a polymer liquid that was prepared by dissolving polyvinylpyrrolidone in an isopropyl alcohol solvent was used.

### EXAMPLE 9

A lithium-sulfur cell was fabricated by the same procedure as in Example 7, except that a polymer liquid that was prepared by dissolving polyethylene oxide in an acetonitrile solvent was used.

### COMPARATIVE EXAMPLE 1

60 wt % of an elemental sulfur (S₈) active material, 20 wt % of a carbon conductive material, and 20 wt % of a polyvinylidene fluoride binder were dissolved in a dimethyl formamide solvent to prepare a slurry. The slurry was coated on a carbon-coated Al current collector, and the coated current collector was dried and pressed. The pressed current collector was dried at room temperature for 2 hours or more and then at 50° C. for 12 hours or more to produce a positive electrode.

Using the positive electrode, and a lithium foil negative electrode, a lithium-sulfur cell was fabricated. As an electrolyte, 1 M LiSO₃CF₃ in a mixed solvent of 1,3-dioxolane, diglyme, sulforane, and dimethoxy ethane (50:20:10:20 volume ratio) was used.

### COMPARATIVE EXAMPLE 2

A lithium-sulfur cell was fabricated by the same procedure as in Comparative Example 1, except that a polyvinylpyrrolidone binder and an isopropyl alcohol solvent were used.

### COMPARATIVE EXAMPLE 3

A lithium-sulfur cell was fabricated by the same procedure as in Comparative Example 1, except that a polyethylene oxide binder and an acetonitrile solvent were used.

The initial capacities of the lithium-sulfur cells according to Examples 1 to 9 and Comparative Examples 1 to 3 were measured by discharging the cells at a 0.1C rate by 1.5V, and the results are presented in Table 1. In addition, to identify the increase effect in capacity of the polymer coatings, the capacity increase (%) of Examples 1 to 3 with respect to Comparative Example 1, Examples 4 to 6 with respect to Comparative Example 2, and Examples 7 to 9 with respect to Comparative Example 3 are also presented in Table 1.

TABLE 1

| | | | Initial | |
|---|---|---|---|---|
| | | Polymer in | capacity | Capacity increase |
| | Binder | coatings | (mAh/g) | by coatings (%) |
| Comparative | PVDF | No coating | 800 | — |
| Example 1 | | | | |
| Example 1 | PVDF | PVDF | 900 | 12.5 |
| Example 2 | PVDF | PVP | 963 | 20.4 |
| Example 3 | PVDF | PEO | 1098 | 37.3 |
| Comparative | PVP | No coating | 950 | — |
| Example 2 | | | | |
| Example 4 | PVP | PVDF | 1050 | 10.5 |
| Example 5 | PVP | PVP | 1132 | 19.2 |
| Example 6 | PVP | PEO | 1285 | 35.3 |
| Comparative | PEO | No coating | 1120 | — |
| Example 3 | | | | |
| Example 7 | PEO | PVDF | 1230 | 9.8 |
| Example 8 | PEO | PVP | 1300 | 16.1 |
| Example 9 | PEO | PEO | 1459 | 30.3 |

*PVDF: Polyvinylidene fluoride
*PVP: Polyvinyl pyrrolidone
*PEO: Polyethylene oxide

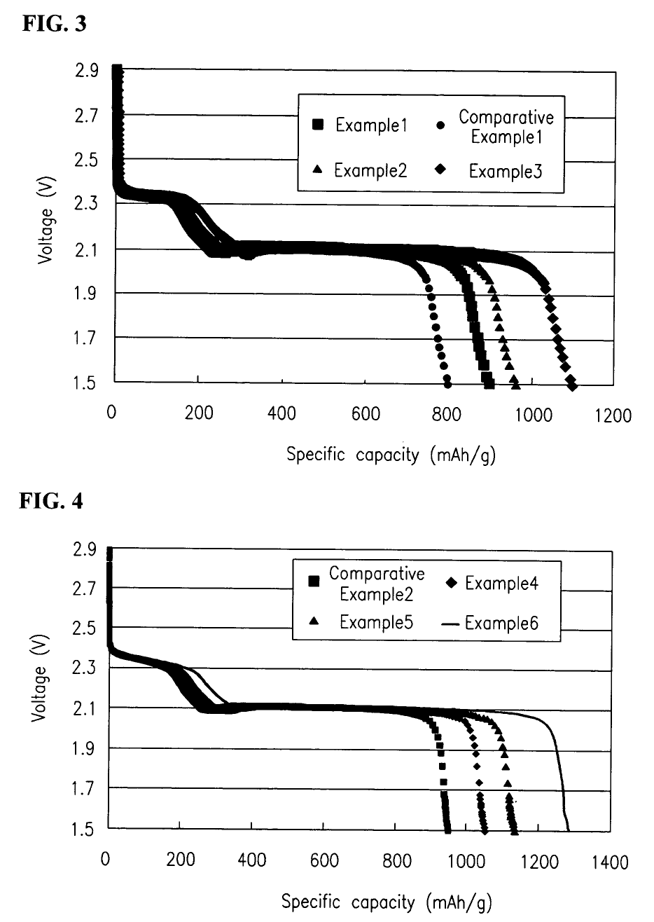

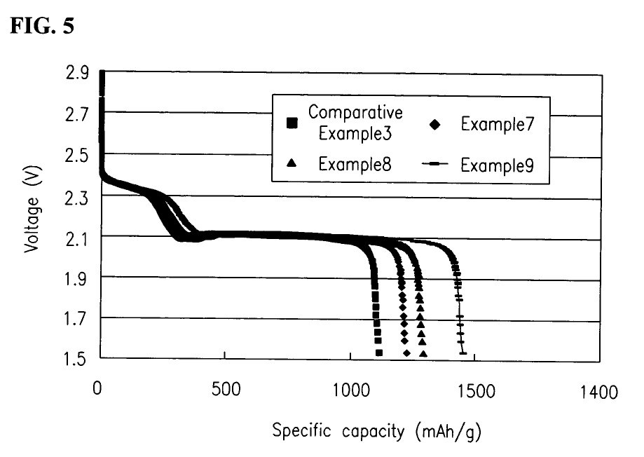

The initial capacity of the cells according to Examples 1 to 3 and Comparative 1 are presented in FIG. 3, the initial capacity of the cells according to Examples 4 to 6 and Comparative Example 2 are presented in FIG. 4, and the initial capacity of the cells according to Examples 7 to 9 and Comparative Examples 3 are presented in FIG. 5.

It is evident from Table 1, and from FIGS. 3 to 5 that show better initial capacity of the cells according to Examples 1 to 9 compared to Comparative Examples 1 to 3, that the polymer coatings increase initial capacity. This result may be due to the polymer coating layer on the positive active material layer absorbing the electrolyte appreciably, which results in activation of the redox reaction.

A test to determine the ability of the polymers used to absorb the electrolyte was done by immersing the polymers in electrolyte, and the results are shown in Table 2.

TABLE 2

| | Polymer/solvent for | | | |
|---|---|---|---|---|
| | preparing a polymer | | | |
| | film | | | |
| | PEO/ | PVDF/ | | Electrolyte for |
| | AcN | DMF | PVP/IPA | immersion |
| Weight of the | 0.058 | 0.051 | 0.051 | 1 M LiSO₃CF₃ |
| polymer prior to | | | | in a mixed |
| immersion (g) | | | | solvent of |
| 5 minutes after | 0.98 | 0.054 | 0.06 | dioxolane, |
| immersion | | | | diglyme, |
| Increased | 1590 | 6 | 18 | sulforane and |
| weight (%) | | | | dimethoxyethane |
| 1 hour after | Soluble | 0.056 | 0.074 | |
| immersion | | | | |
| Increased | — | 10 | 45 | |
| weight (%) | | | | |
| 3 hours after | — | 0.061 | 0.09 | |
| immersion | | | | |
| Increased | — | 20 | 76 | |
| weight (%) | | | | |
| 24 hours after | — | 0.061 | 0.091 | |
| immersion | | | | |
| Increased | — | 20 | 78 | |
| weight (%) | | | | |

*AcN: Acetonitrile
*DMF: Dimethylformamide
*IPA: isopropyl alcohol

In the test, the amount of electrolyte used was 100 times the amount of the polymer. The term “soluble” in Table 2 indicates that the polymer absorbed a large amount of the electrolyte and reached a substantial dissolution state.

The results from Tables 1 and 2 indicate that the coatings increase capacity, and that the capacity increases as the effectiveness of the polymer in absorbing electrolyte increases. As described above, the positive electrode of the present invention may improve capacity by a minimum of 9.8% and a maximum of 37.3%.

Such an exhibited increase in capacity because of the coatings is an effect that is unique to the lithium-sulfur batteries, and the effect may not be exhibited in lithium-ion batteries. To demonstrate the lack of exhibition of an increase in capacity because of coatings in lithium-ion batteries, the following tests were done.

### REFERENCE EXAMPLE 1

A LiCoO₂ positive active material, a polyvinylidene fluoride binder, and a Super-P conductive material at a weight ratio of 94:3:3 were mixed in an N-methylpyrrolidone solvent to prepare a positive active material slurry for a lithium-ion battery. The slurry was coated on an Al current collector and dried followed by pressing, thus obtaining a positive electrode for a lithium-ion battery.

Using the positive electrode and a lithium foil counter electrode, a lithium ion half cell was fabricated. As an electrolyte, 1.0 M LiPF₆ in a mixed solvent of ethylene carbonate, dimethyl carbonate, and ethyl methyl carbonate (3:3:4 volume ratio) was used.

### REFERENCE EXAMPLE 2

Polyvinylidene fluoride was dissolved in a dimethyl formamide solvent to prepare a 5 wt % polymer liquid. The polymer liquid was coated on the positive electrode produced according to Reference Example 1, and dried at room temperature for 2 hours or more then at 50° C. for 12 hours or more. Using the coated positive electrode and a lithium foil counter electrode, a lithium ion half cell was fabricated. As an electrolyte, 1.0 M LiPF₆ in a mixed solvent of ethylene carbonate, dimethyl carbonate, and ethyl methyl carbonate (3:3:4 volume ratio) was used.

### REFERENCE EXAMPLE 3

A lithium-ion half cell was fabricated by the same procedure as in Reference Example 2, except that a polymer liquid that was prepared by dissolving polyvinyl pyrrolidone in an isopropyl alcohol solvent was used.

### REFERENCE EXAMPLE 4

A lithium-ion half cell was fabricated by the same procedure as in Reference Example 2, except that a polymer liquid that was prepared by dissolving polyethylene oxide in an acetonitrile solvent was used.

The initial capacities of the cells according to Reference Examples 1 to 4 were determined, and the results are shown in Table 3. In addition, increases in capacity because of the coatings, that is, percentages of initial capacity of the cells according to Reference Examples 2 to 4 with respect to Reference Example 1, are shown in Table 3.

TABLE 3

| | | Polymer in | Initial capacity | Increase in capacity |
|---|---|---|---|---|
| | Binder | coatings | (mAh/g) | by coating (%) |
| Reference | PVDF | No coating | 160 | — |
| Example 1 | | | | |
| Reference | PVDF | PVDF | 160 | 0 |
| Example 2 | | | | |
| Reference | PVDF | PVP | 160 | 0 |
| Example 3 | | | | |
| Reference | PVDF | PEO | 160 | 0 |
| Example 4 | | | | |

*PVDF: Polyvinylidene fluoride

The results clearly indicate that the polymer coatings did not have an effect on an increase in capacity in the lithium ion batteries.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A positive electrode of a lithium-sulfur battery, comprising:
a current collector;
a positive active material layer on the current collector; and
a polymer layer on the positive active material layer.

2. The positive electrode of claim 1, wherein the polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyvinyl ether, acrylonitrile-butadiene rubber, styrene-butadiene rubber, acrylonitrile-butadiene-styrene, sulfonate styrene/ethylene-butylene triblock copolymer, polyethylene oxide, and a mixture thereof.

3. The positive electrode of claim 2, wherein the polymer is selected from the group consisting of polyethylene oxide, polyvinyl pyrrolidone and polyvinylidene fluoride.

4. The positive electrode of claim 1, wherein the polymer layer further includes at least one lithium salt selected from the group consisting of lithium hexafluorophosphate, lithium tetrafluoroborate, lithium hexafluoroarsenate, lithium perchlorate, lithium trifluoromethane sulfonate, lithium bis(trifluoromethyl) sulfonimide, or a mixture thereof.

5. The positive electrode of claim 1, wherein the polymer layer further includes an inorganic material.

6. The positive electrode of claim 5, wherein the inorganic material is selected from the group consisting of colloidal silica, amorphous silica, surface treated silica, colloidal alumina, amorphous alumina, conductive carbon, tin oxide, titanium oxide, titanium sulfide, zirconium oxide, iron oxide, iron sulfide, iron titanate, vanadium titanate, vanadium oxide, and a mixture thereof.

7. The positive electrode of claim 1, wherein the positive active material is selected from the group consisting of elemental sulfur, an organic-sulfur compound, and a carbon-sulfur polymer ((C₂Sₓ)ₙ: x=2.5 to 50, n≧2).

8. A method of producing a positive electrode of a lithium-sulfur battery, comprising:
mixing a positive active material, a conductive material, and a binder in an organic solvent to prepare a positive active material composition;
coating the positive active material composition on a current collector to form a positive active material layer on the current collector; and
immersing the positive active material layer on the current collector in a polymer liquid to form a polymer layer on the positive active material layer on the current collector.

9. The method of claim 8, wherein the polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyvinyl ether, acrylonitrile-butadiene rubber, styrene-butadiene rubber, acrylonitrile-butadiene-styrene, sulfonate styrene/ethylene-butylene triblock copolymer, polyethylene oxide, and a mixture thereof.

10. The method of claim 9, wherein the polymer is selected from the group consisting of polyethylene oxide, polyvinyl pyrrolidone and polyvinylidene fluoride.

11. The method of claim 9, wherein the polymer liquid further includes at least one lithium salt selected from the group consisting of lithium hexafluorophosphate, lithium tetrafluoroborate, lithium hexafluoroarsenate, lithium perchlorate, lithium trifluoromethane sulfonate, lithium bis(trifluoromethyl) sulfonimide, or a mixture thereof.

12. The method of claim 9, wherein the polymer layer further includes an inorganic material.

13. The method of claim 12, wherein the inorganic material is selected from the group consisting of colloidal silica, amorphous silica, surface treated silica, colloidal alumina, amorphous alumina, conductive carbon, tin oxide, titanium oxide, titanium sulfide, zirconium oxide, iron oxide, iron sulfide, iron titanate, vanadium titanate, vanadium oxide, and a mixture thereof.

14. The method of claim 8, wherein the positive active material is selected from the group consisting of elemental sulfur (S8), an organic-sulfur compound, and a carbon-sulfur polymer ((C2Sₓ)ₙ: x=2.5 to 50, n≧2).

15. A lithium-sulfur battery comprising:
a positive electrode comprising a current collector, a positive active material layer on the current collector, and a polymer layer on the positive active material;
a negative electrode comprising a negative active material selected from a material that reversibly intercalates or deintercalates lithium ions, a material that reacts with lithium ions to prepare a lithium-included compound, a lithium metal, and a lithium alloy; and
an electrolyte.

16. The lithium-sulfur battery of claim 15, wherein the negative electrode further comprises one of an inorganic protective material and an organic protective layer.

17. The lithium-sulfur battery of claim 16, wherein the inorganic protective layer includes at least one selected from the group consisting of Li, P, O, S, N, B, Al, F, Cl, Br, I, As, Sb, Bi, Si, Ge, In, Tl, Mg, Ca, Sr, and Ba.

18. The lithium-sulfur battery of claim 16, wherein the organic protective layer includes one of polyethylene oxide and polypropylene oxide.

19. The lithium-sulfur battery of claim 16, wherein the organic protective layer includes at least one acrylate-based monomer selected from the group consisting of polyethylene glycol diacrylate, polypropylene glycol diacrylate, ethoxylated glycol diacrylate, polypropylene glycol diacrylate, ethoxylated neopentyl glycol diacrylate, ethoxylated bisphenol A diacrylate, ethoxylated aliphatic urethane acrylate, ethoxylated alkylphenol acrylate and alkyl acrylate.

20. The lithium-sulfur battery of claim 16, wherein the organic protective layer includes a polymer selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, sulfonated styrene/ethylene-butylene triblock copolymer, polyethylene oxide, and a mixture thereof.

21. The lithium-sulfur battery of claim 15, wherein the polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyvinyl ether, acrylonitrile-butadiene rubber, styrene-butadiene rubber, acrylonitrile-butadiene-styrene, sulfonate styrene/ethylene-butylene triblock copolymer, polyethylene oxide, and a mixture thereof.

22. The lithium-sulfur battery of claim 21, wherein the polymer is selected from the group consisting of polyethylene oxide, polyvinyl pyrrolidone, and polyvinylidene fluoride.

23. The lithium-sulfur battery of claim 15, wherein the polymer liquid further includes at least one lithium salt selected from the group consisting of lithium hexafluorophosphate, lithium tetrafluoroborate, lithium hexafluoroarsenate, lithium perchlorate, lithium trifluoromethane sulfonate, lithium bis(trifluoromethyl) sulfonimide, or a mixture thereof.

24. The lithium-sulfur battery of claim 15, wherein the polymer layer further includes an inorganic material.

25. The lithium-sulfur battery of claim 24, wherein the inorganic material is selected from the group consisting of colloidal silica, amorphous silica, surface treated silica, colloidal alumina, amorphous alumina, conductive carbon, tin oxide, titanium oxide, titanium sulfide, zirconium oxide, iron oxide, iron sulfide, iron titanate, vanadium titanate, vanadium oxide, and a mixture thereof.
